(19) United States
(12) Patent Application Publication
(10) Pub. No.: US 2026/0015243 A1
(43) Pub. Date: Jan. 15, 2026

(54) DIRECT SYNTHESIS OF TWO-DIMENSIONAL CARBIDE AND NITRIDE MXENES

(71) Applicant: THE UNIVERSITY OF CHICAGO, Chicago, IL (US)

(72) Inventors: Dmitri V. Talapin, La Grange Park, IL (US); Di Wang, Chicago, IL (US)

(21) Appl. No.: 18/994,955

(22) PCT Filed: Aug. 18, 2023
(86) PCT No.: PCT/US23/72474

§ 371 Date: Jan. 15, 2025

Related U.S. Application Data
(60) Provisional application No. 63/399,931, filed on Aug. 22, 2022.

(51) Int. Cl. C01B 32/90; C01B 21/06

(52) U.S. Cl. CPC C01B 32/90; C01B 21/06; C01P 2002/72; C01P 2002/85; C01P 2004/03; C01P 2004/20

(57) ABSTRACT

Methods for the direct synthesis of two-dimensional transition metal carbides and nitrides known as MXenes by reacting a transition metal with a carbon halide compound or with a transition metal compound and a carbon or nitrogen source molecule are provided. The direct syntheses can be carried out using chemical vapor deposition (CVD) growth on a transition metal surface. The CVD growth of the MXenes can be used to form aligned sheets of the MXenes on a transition metal surface or hollow vesicles formed from sheets of the MXenes.

### CROSS-REFERENCE TO RELATED APPLICATIONS

The present application claims priority to U.S. provisional patent application No. 63/399,931 that was filed Aug. 22, 2022, the entire contents of which are incorporated herein by reference.

### REFERENCE TO GOVERNMENT RIGHTS

This invention was made with government support under grant number 2004880 awarded by the National Science Foundation and grant number FA9550-18-1-0099 awarded by the Air Force Office of Scientific Research. The government has certain rights in the invention.

### BACKGROUND

Two-dimensional (2D) transition metal carbides and nitrides known as MXenes are a large family of 2D materials. Since the discovery of the MXene Ti₃C₂Tₓ (T=O, OH, and F) in 2011, MXenes have been commonly synthesized from crystalline MAX phases (A being Al, Si, Zn, etc.) by selective etching of A atoms using, for example, HF-containing solutions or Lewis acidic molten salts, followed by the delamination of the MXene sheets. (M. Naguib et al., Adv. Mater. 23, 4248-4253 (2011).) Interest in MXenes continues to grow due to their prospects for applications in energy storage, electromagnetic interference (EMI) shielding, transparent conductive layers, superconductivity, and catalysis. Moreover, the T components in MXenes can be replaced with covalently-bonded surface groups, including organic molecules, either during etching of the MAX phase, or by post-synthetic modifications of surface groups. As such, opportunities are available to combine the benefits of 2D MXenes, such as low metal diffusion barrier and excellent electrical and thermal conductivity, with the nearly endless tailorability of molecular surface groups.

Traditional preparations of MXenes by high-temperature synthesis and chemical etching of MAX or non-MAX phases require high energy consumption, show poor atom economy, and use large amounts of hazardous hydrofluoric acid or Lewis acidic molten salts. The development of direct synthetic methods would greatly facilitate practical applications of the rapidly developing family of functional MXenes. An ideal approach would involve a reaction of inexpensive precursors into MXenes bypassing intermediate MAX phases. In 2019, Druffel et al. reported the synthesis of Y₂CF₂ with MXene-like structure by the solid-state reaction between YF₃, Y metal, and graphite, based on the previously reported synthesis of Y, Sc, and Zr metal carbide halides by Hwu et al. in 1986. (D. L. Druffel et al., Chem. Mater. 31, 9788-9796 (2019); S. J. Hwu et al., Inorg. Chem. 25, 283-287 (1986).)

### SUMMARY

Methods for the direct synthetic synthesis of MXenes and MXenes synthesized using the methods are provided. The methods are scalable and do not rely upon the formation or selective etching of a MAX phase.

One embodiment of a method for the direct synthesis of a two-dimensional transition metal carbide or nitride MXene having the formula M₂XT₂, where M is an early transition metal atom, X is carbon or nitrogen, and T is a surface terminating halogen atom, is carried out by reacting an early transition metal with: a carbon halide compound or an early transition metal halide compound; and a carbon-precursor molecule or a nitrogen-precursor molecule at temperature at which the reaction forms the two-dimensional transition metal carbide or nitride MXene. The direct synthesis can be conducted via chemical vapor deposition growth on a surface of a substrate comprising the early transition metal by: exposing the surface to a vapor comprising the carbon halide compound or the early transition metal halide compound and the carbon-precursor molecule or the nitrogen-precursor molecule; and reacting the early transition metal of the surface with the carbon halide compound or the early transition metal halide compound and the carbon-precursor molecule or the nitrogen-precursor molecule at temperature at which the reactions form the two-dimensional transition metal carbide or nitride MXene.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1, panels (a)-(c) are schematic diagrams showing the morphology of a “carpet” formed from vertically aligned MXene sheets (panel (a)), a buckled carpet (panel (b)), and an MXene microsphere (panel (c)).

FIGS. 2A-2H show a method for the direct synthesis (“DS”) and characterization of a DS-Ti₂CCl₂ MXene, as described in Example 1. FIG. 2A shows a schematic diagram of the synthesis. FIG. 2B shows an x-ray diffraction (XRD) pattern and Rietveld refinement of a DS-Ti₂CCl₂ prepared by reacting Ti, graphite, and TiCl₄ in a reaction vessel at 950° C. FIG. 2C shows XRD patterns of dispersible delaminated and sonicated DS-Ti₂CCl₂ MXenes. FIG. 2D shows a scanning electron microscope (SEM) image and FIG. 2E shows energy dispersive x-ray (EDX) elemental mapping of a DS-Ti₂CCl₂ stack. FIG. 2F shows a high resolution high-angle annular dark field (HAADF) image representing the layered structure of DS-Ti₂CCl₂. FIG. 2G shows a powder XRD pattern for a DS-Ti₂CCl₂ prepared by reacting Ti, carbon nanotubes (CNTs) or C₆₀, and TiCl₄ in a reaction vessel at 950° C. FIG. 2H shows an SEM image of the DS-Ti₂CCl₂ prepared by reacting the Ti, C₆₀, and TiCl₄.

FIGS. 3A-3E show chemical vapor deposition (CVD) growth of MXenes, as described in Example 2. FIG. 3A shows a schematic diagram of the CVD reactions. FIG. 3B shows XRD patterns and Rietveld refinement for CVD-Ti₂CCl₂ and CVD-Ti₂NCl₂. FIG. 3C shows Raman spectra of CVD-Ti₂CCl₂ and CVD-Ti₂NCl₂ MXenes in comparison to that of a traditional MS-Ti₂CCl₂ MXene, which was synthesized by etching Ti₂ALC MAX phase with CdCl₂ molten salt. FIG. 3D shows frontal and cross-sectional SEM images of CVD-Ti₂CCl₂. FIG. 3E shows high resolution HAADF images and electron energy loss spectroscopy (EELS) elemental mapping of CVD-Ti₂NCl₂.

FIGS. 4A-4J show morphologies of CVD-Ti₂CCl₂. FIGS. 4A and 4B show schematic diagrams illustrating a (FIG. 4A) reaction zone and (FIG. 4B) buckling mechanism of CVD-Ti₂CCl₂ through which microspheres are formed. SEM images show that the morphology of CVD-Ti₂CCl₂ can be varied by tuning reaction conditions: FIG. 4C shows microspheres growing on CVD-Ti₂CCl₂ carpets; FIG. 4D shows individual microspheres; and FIG. 4E shows a fragmented microsphere showing a hollow center. FIGS. 4F, 4G, and 4H show scanning transmission electron microscope (STEM) images showing vertically aligned MXene sheets constitute the microspheres, while a void is left at the center. FIGS. 4I and 4J show SEM images of the CVD-Ti₂CCl₂ microspheres before (FIG. 4I) and after focused ion beam (FIB) milling (FIG. 4J).

FIGS. 5A-5D show powder XRD (FIG. 5A) and SEM images (FIGS. 5B-5D) of Ti₂CCl₂ MXene (* are diffraction signals from small amount of TiCₓ byproduct) synthesized from different carbon halide precursors (C₂Cl₄—FIG. 5B and C₂Cl₁₆—FIGS. 5C and 5D), as described in Example 3.

FIGS. 6A-6D show powder XRD (FIG. 6A) and SEM images (FIGS. 6B-6D) of Nb₂CCl₂ and Nb₂CBr₂ MXenes synthesized from different carbon halide precursors (C₂Cl₄—FIG. 6B and CBr₄—FIGS. 6C and 6D), as described in Example 3.

FIG. 7 shows a powder XRD for a Zr₂CBr₂ MXene and a Zr₂CCl₂ MXene synthesized from CBr₄ and C₂Cl₄, respectively.

FIGS. 8A and 8B show powder XRD (FIG. 8A) and an SEM (FIG. 8B) image of Nb₂CCl₂ MXene synthesized by CVD (compared to a Nb₂CCl₂ standard) from an Nb surface and a C₂Cl₄.

FIGS. 9A-9F show the electrochemical energy storage properties of Ti₂CCl₂ MXenes. FIG. 9A. Cyclic voltammetry (CV) profiles of delaminated DS-Ti₂CCl₂ with various negative cut-off potentials at a scan rate of 0.5 mV·s⁻¹. FIG. 9B. CV profiles of delaminated DS-Ti₂CCl₂ at different scan rates from 0.5 to 100 mV·s⁻¹. Differential capacity Q was derived from differential capacitance C: Q=C×2.8 V/3.6. FIG. 9C. Change of DS-MXene electrode capacity and capacitance versus the discharge time during CV recorded at various potential scan rates. The inset shows b-value determination. FIG. 9D. Galvanostatic charging/discharging (GCD) profiles of DS-Ti₂CCl₂ from current densities of 0.1 to 10 Å·g⁻¹.

FIG. 9E. GCD profiles of CVD-Ti₂CCl₂ from current densities of 3.4 to 650 Å. FIG. 9F. Normalized galvanostatic discharge capacity of CVD-Ti₂CCl₂ and DS-Ti₂CCl₂ electrodes from 0.4 to ˜160 C. Absolute capacity of DS-Ti₂CCl₂ is shown in the secondary y axis as a reference.

### DETAILED DESCRIPTION

Methods for the direct synthesis of MXenes by reacting a transition metal with a carbon halide compound or with a transition metal compound and a carbon or nitrogen source molecule are provided. Some embodiments of the methods are carried out via CVD growth of the MXenes on a transition metal surface. The CVD growth of the MXenes can be used to form aligned sheets of the MXenes extending outwardly from the transition metal surface or hollow microspheres formed from sheets of the MXenes. The MXenes are useful in a wide range of applications and devices, including supercapacitors, batteries, and as electromagnetic interference (EMI) shielding.

The directly synthesized MXenes have excellent energy storage capacity for Li-ion intercalation, and the aligned individual 2D MXene sheets are well-suited for supercapacitor applications. The direct synthesis methods can produce a variety of carbide and nitride MXenes, including some that have not previously been synthesized by MAX phase etching methods, such as Zr₂CCl₂, Zr₂CBr₂, Ti₂NCl₂, and Nb₂CBr₂.

The MXenes made using the methods described herein are 2D transition metal carbides and nitrides (MXenes, where M stands for an early transition metal and X is C or N) that can be represented by the chemical formula M₂XT₂, where layers of the early transition metal (M) are interleaved by layers of carbon or nitrogen (X), and T represents surface terminating atoms or chemical groups bonded to the outer M layers. In the as-synthesized MXenes made using the methods disclosed herein, T represents halogen atoms. However, these halogen atoms can be removed using, for example, reductive elimination, or replaced by other surface terminations using, for example, nucleophilic substitution, post-synthesis.

The early transition metals are 3d-5d block transition metals (Groups 3-7 of the periodic table), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), and manganese (Mn). MXenes that can be synthesized using the methods described herein include those having the chemical formula M₂XT₂, including, but not limited to, Ti₂CCl₂, Ti₂NCl₂, Zr₂CCl₂, Zr₂CBr₂, Nb₂CCl₂, and Nb₂CBr₂. The ability to synthesize nitride MXenes, such as M₂NT₂ MXenes, is particularly advantageous, since nitride MXenes have a variety of attractive properties, including ferromagnetism and high conductivity, as compared to carbide MXenes.

The transition metal reactants are generally solid reactants and may be provided, for example, in the form of a powder or a substrate on which the reaction occurs. The halide compound reactants are transition metal halides or carbon halides. The transition metal halides, which can be used to form 2D transition metal carbide MXenes or 2D transition metal nitride MXenes, contain the same transition metal as the transition metal reactant. If a carbon halide reactant is used, it can act as a carbon source and a halide source and, therefore, no additional carbon source or transition metal halide reactants are needed for the reaction.

The transition metal halide reactants include chloride, bromide, iodide, and fluoride compounds. By way of illustration, examples of transition metal halides that can be used include early transition metal trihalides (MT₃ compounds, where T is a halogen atom), such as titanium (III) chloride (TiCl₃), and early transition metal tetrahalides (MT₄ compounds), such as titanium tetrachloride (TiCl₄), zirconium tetrachloride (ZrCl₄), and zirconium tetrabromide (ZrBr₄). Examples of carbon halides that can be used include C₂T₄ halocarbons, such as C₂Cl₄, C₂T₆ halocarbons, such as C₂Cl₆, and carbon tetrahalides (CT₄), such as CBr₄.

If the transition metal halide reactants are used, a carbon-containing molecule or a nitrogen-containing molecule is included in the reaction mixture to act as a carbon or nitrogen source. These carbon- and nitrogen-containing molecules are referred to as carbon-precursors and nitrogen-precursors, respectively. Examples of carbon-precursors include lower hydrocarbons CₙH₍ₙ₊₂₎, where n has a value from 1 to 6. Other examples include carbon particles, such as graphite particles, graphene flakes, and carbon nanoparticles, where carbon nanoparticles are carbon particles having at least one dimension (e.g., diameter or thicknesses) of less than 1000 nm, including particles having at least one dimension of less than 100 nm. Examples of carbon nanoparticles include carbon nanotubes and C₆₀. For CVD-based growth of MXenes, the carbon and nitrogen-precursors should be selected such that they have a sufficiently high vapor pressure for efficient transport in the CVD reactor, as described in more detail below, and decompose at temperatures practical for use in CVD. For these reasons, methane (CH₄), volatile carbon halides (C₂Cl₄) and nitrogen (N₂) are suitable carbon- and nitrogen-precursors, respectively, for CVD growth.

The direct reaction of the transition metals, halide compounds, and carbon or nitrogen sources can be carried out by combining the reactants in a reaction vessel where they react to form the MXene. The use of reactants that are solid or liquid at the reaction temperature, such as transition metal powders and graphite, can be used to simplify the synthesis. However, one or more volatile reactants can be used. The reactants can be heated to thermally induce the reaction, increase the reaction rate, and/or increase the yield of the MXene phase over other metal carbide or metal nitride phases that are formed as products of the reaction. The optimal reaction temperature will depend on the reactant being used. Generally, however, temperatures in the range from about 700° C. to 1100° C., including from 800° C. to 1000° C., are suitable.

The MXenes synthesized by combining the reactants in a reaction vessel at high temperature are formed as stacks of monolayer MXene sheets, and these stacks can be delaminated to obtain individual monolayer MXene sheets. Methods for delaminating stacks of MXene sheets are known and an illustrative example is provided in Example 1 for guidance. The monolayer MXene sheets have excellent pseudocapacitive energy storage properties originating from efficient ion intercalation between the 2D monolayers. Their excellent electrochemical energy storage characteristics stem from the combination of large surface-to-volume ratio and high electrical conductivity. However, restacking of the MXene sheets can reduce the surface area that is easily accessible for intercalating ions.

An alternative method for the direct synthesis of the MXenes that alleviates the problem of restacking and provide unique MXene morphologies is direct synthesis via CVD. CVD growth is a bottom-up growth process in which the MXenes are formed epitaxially on the surface of the transition metal growth substrate by the thermal decomposition of the carbon halide compounds or thermal decomposition of the transition metal halide compounds and the carbon- or nitrogen-precursor molecules. CVD growth generally proceeds through a series of stages. First, the vapor-phase halide and, if used, carbon- and nitrogen-precursors, diffuse to the transition metal surface of the substrate where they are adsorbed. Reactions between the transition metal of the surface and the vapor-phase reactants grow the MXenes from the surface, and gaseous by-products of the reactions are separated from the surface.

In preparation for CVD growth, the growth substrate is loaded into the CVD reactor chamber and heated to a temperature at which the MXene growth will be carried out-typically a temperature in the range from 700° C. to 1100° C. The reactants are introduced into the CVD reactor chamber as a vapor comprising the reactants and, typically, an inert gas carrier. The reactants are transported to the substrate surface via fluid transport and/or diffusion where they undergo decomposition and heterogeneous reactions with the transition metal of the growth surface to form the MXenes. Because the reactions on the substrate surface may be thermally driven or controlled, the CVD reactor is equipped with a heater, or other energy source, in thermal communication with the substrate to heat the substrate to a temperature that promotes the reactions. The CVD reactor will also include a vacuum pump in fluid communication with the reactor chamber to remove the by-product gasses and maintain the chamber pressure at a desired sub-atmospheric pressure during film growth.

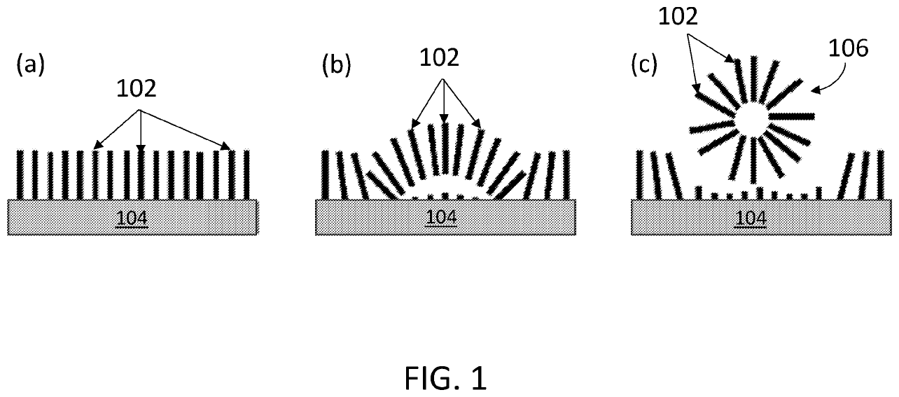

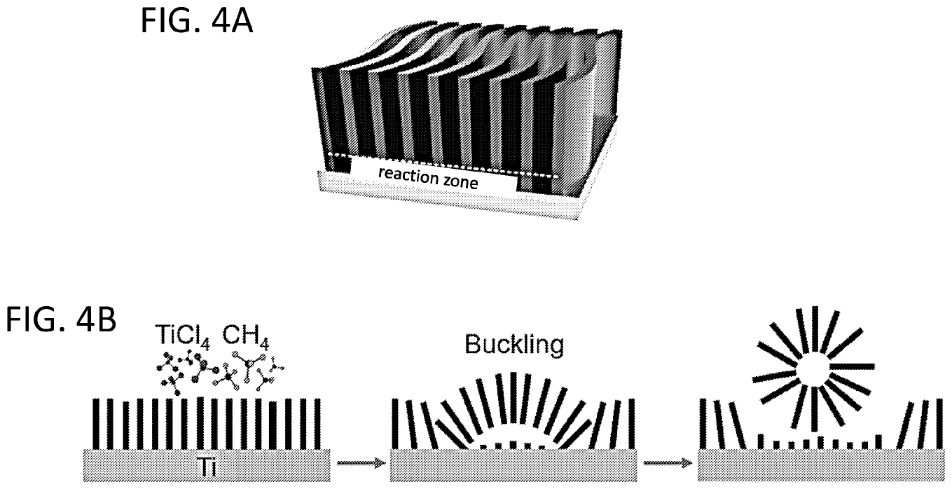

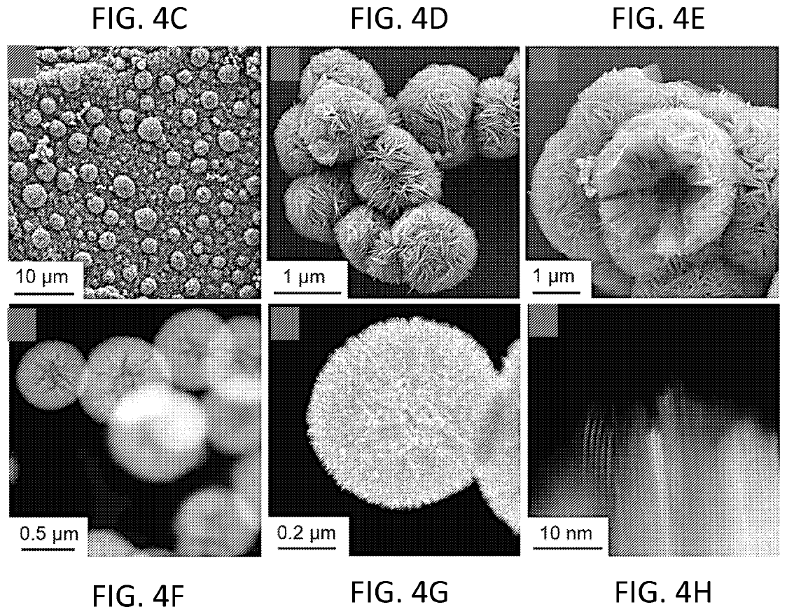

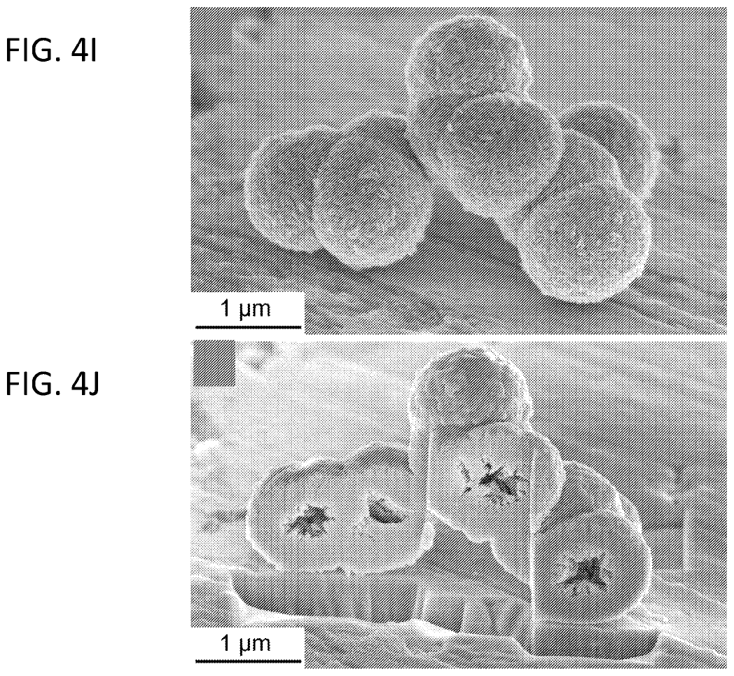

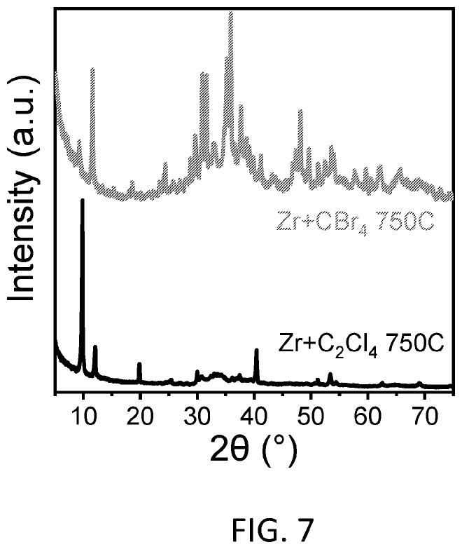

The CVD growth of the MXenes can be used to form a plurality of sheets of MXenes that are bound to the growth substrate along a sheet edge, referred to herein as “carpets.” As the MXenes continue to grow upward from the CVD growth surface, the MXene carpets can become “buckled” and then converted into hollow MXene microspheres composed of MXene sheets radiating outward from the center of the microsphere. Alignment of the surface bound MXene sheets in the carpets and in the microspheres allows for efficient ion intercalation and fast charging and discharging cycles for battery electrodes made from the CVD-grown MXenes. FIG. 1, panels (a)-(c) show the morphology, schematically, of a layer of CVD-grown MXene. The layer includes a plurality of MXene plates 102 comprising multiple aligned MXenes sheets aligned on the surface of a growth substrate 104 (FIG. 1, panel (a)), buckled on a surface (FIG. 1, panel (b)), and in the form of microspheres 106 (FIG. 1, panel (c)). FIGS. 4C-4H, which are discussed in greater detail in Example 2, provide images of the morphology of the microspheres, including the vertical alignment of MXene sheets that make up a microsphere having a void at its center (FIG. 4H), where “vertical” alignment refers to alignment along the plane of the 2D sheet of the MXene. The MXene spheres are referred to herein as “microspheres” due to their micrometer-scale diameters. The microspheres typically have diameters of less than 100 m and, more typically, less than 10 μm. By way of illustration, the MXene microspheres may have diameters in the range from 0.5 μm to 5 μm. However, MXene microspheres having diameters outside of this range can be formed. The term “microsphere” does not indicate a perfectly spherical circumference or perfectly smooth surface; the MXene microspheres can have substantially, but not perfectly, spherical shapes, as illustrated in the images shown in FIGS. 4C-4G and FIG. 7B, which are discussed in greater detail in the examples.

Without intending to be bound to any one theory behind the CVD growth of the MXenes with unique morphologies, the formation of these morphologies can be explained as follows. CVD growth of MXenes involves the reaction of the gaseous reagents with the transition metal surface. As the lengths of the growing MXene sheets increase, the diffusion of gaseous reagents toward the reaction zone near the growth surface should slow down, and the growth of the MXenes would be expected to be self-limiting. However, an alternative growth mechanism in which the uniform growth of the MXenes is followed by the formation of “bulges” on the surface that further evolve into MXene microspheres (also referred to as “vesicles”) would bypass this kinetic bottleneck. When the microspheres detach from the growth surface, the process repeats itself, enabling continuous synthesis of MXenes.

### EXAMPLES

### Example 1: Direct Synthesis of MXenes Using Metal Halides

This Example demonstrates that Ti₂CCl₂ and Ti₂NCl₂ MXenes can be directly synthesized from Ti metal, titanium chlorides (TiC₃ or TiCl₄), and various carbon or nitrogen sources (graphite, carbon nanotubes, C₆₀, CH₄, NaN₃, or N₂).

This Example further demonstrates chemical vapor deposition (CVD) synthesis of extended carpets of Ti₂CCl₂, Ti₂NCl₂, Zr₂CCl₂, and Zr₂CBr₂ MXene sheets oriented perpendicular to the substrate. Such orientations make MXene surfaces easily accessible for ion intercalation and (electro)chemical transformations by exposing edge sites with high catalytic activity.

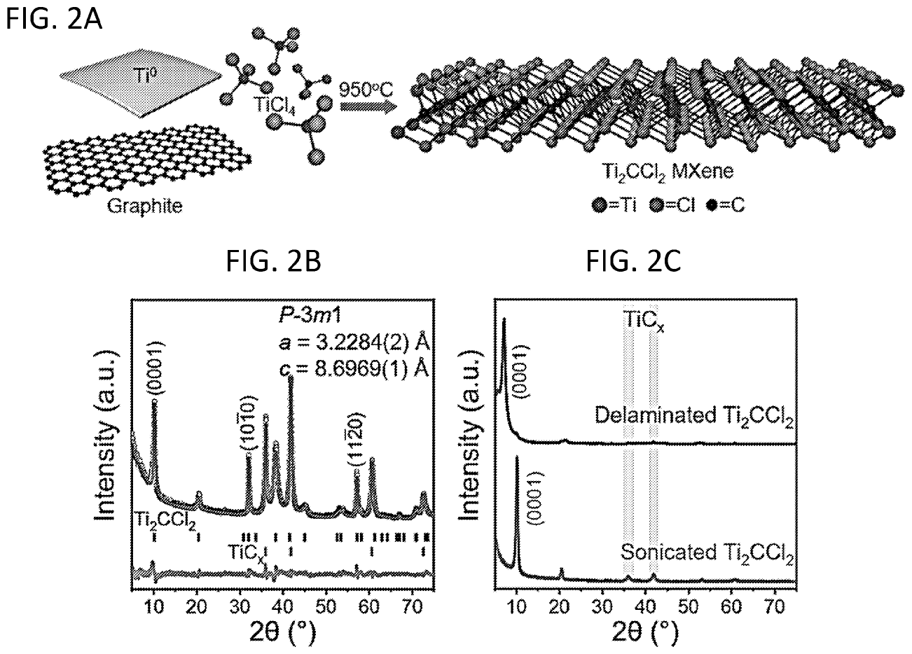

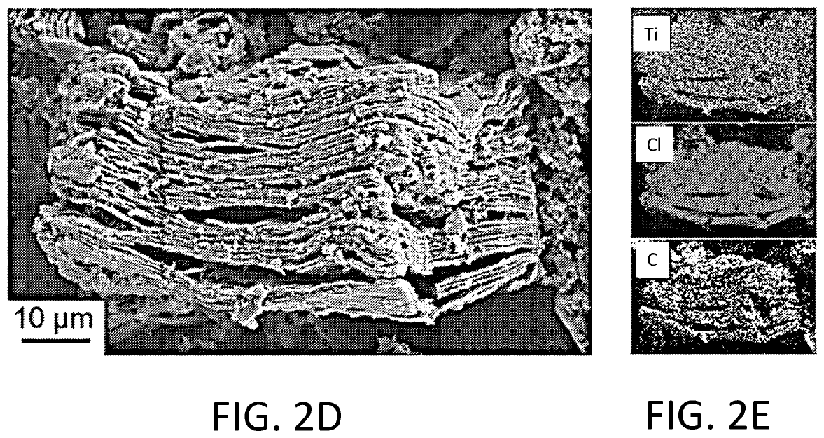

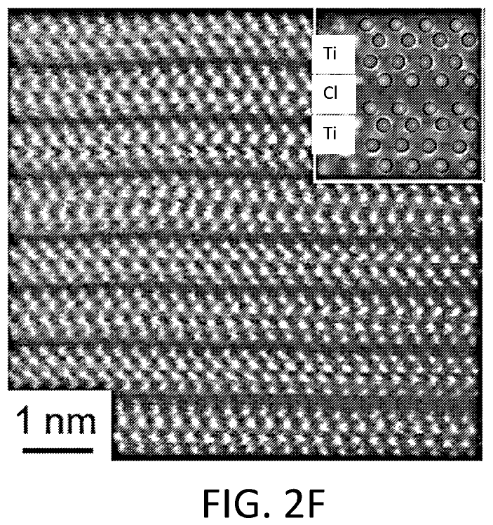

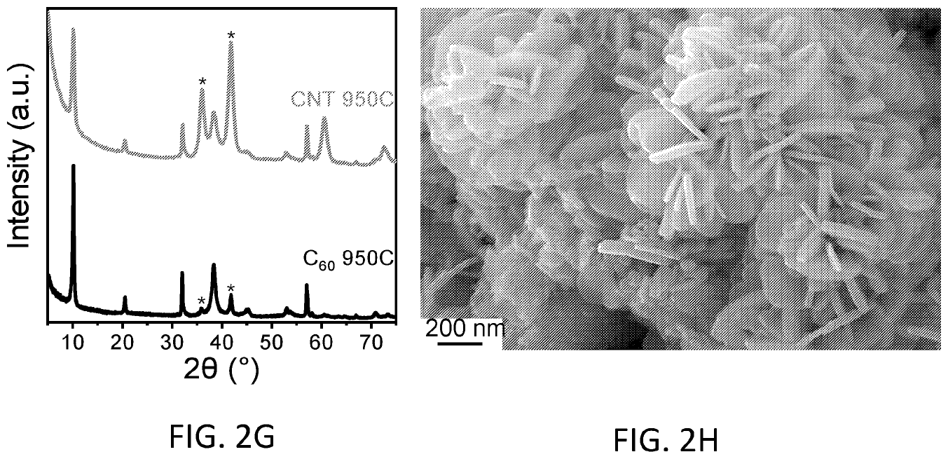

A schematic of the DS-Ti₂CCl₂ synthesis by high-temperature reaction between Ti, graphite and TiCl₄ is shown in FIG. 2A. This reaction can be carried out on a multigram scale and is easily amenable to further scaling. Powder X-ray diffraction (XRD) and structural analysis by Rietveld refinement of the as-synthesized reaction products (FIG. 2B) show the presence of a Ti₂CCl₂ MXene phase with the lattice parameters a=3.2284(2) A and c=8.6969(1) A, which are close to the values reported for Ti₂CCl₂ MXene synthesized by etching of Ti₂AlC MAX phase with Lewis acidic molten salt (referred to as MS-MXenes). (V. Kamysbayev, et al., Science 369, 979-983 (2020).) Cubic TiCₓ (x=0.5-1) was often present as a byproduct but could be efficiently removed by its precipitation from nonaqueous dispersions of the raw product prepared, e.g., by ultrasonic dispersion in propylene carbonate (PC) or by delamination of DS-Ti₂CCl₂ with n-butyllithium (n-BuLi) (FIG. 2C).

The formation of DS-Ti₂CCl₂ MXene was observed beginning at around 850° C., and the yield of MXene was maximal at 950° C. TiCₓ became the dominant reaction product at temperatures higher than 1000° C. At 950° C., the formation of the Ti₂CCl₂ phase was observed after two hours, and the ratio between DS-Ti₂CCl₂ and TiCₓ products did not change significantly after increasing the reaction time from 2 hours to 10 days at this temperature. This naturally raises a question as to whether MXene is the kinetic or thermodynamic product of the reaction described in FIG. 2A. It was noticed that the MXene phase did not form when a reaction of TiCₓ with Ti and TiCl₃ or TiCl₄ was attempted. On the other hand, a prolonged heating of purified MSTi₂CCl₂ at 950° C. resulted in a partial conversion into TiCₓ. It can be concluded from these observations that Ti₂CCl₂ is a kinetically favored phase forming in competition with TiCₓ.

The XRD patterns of DS-Ti₂CCl₂ synthesized from TiCl₃ or TiCl₄ are very similar, as are scanning electron microscopy (SEM) images of the products' morphology, represented by large MXene stacks (FIGS. 2D, 2E). A high-resolution high-angle annular dark field (HAADF) scanning transmission electron microscopy (STEM) image of DS-Ti₂CCl₂ MXene oriented along the [21̅1̅0] zone axis is shown in FIG. 2F. The center-to-center distance between MXene sheets calculated from HAADF images is about 0.88 nm, in agreement with the value of 0.87 nm measured from XRD. DS-Ti₂CCl₂ MXene sheets showed an atomic ratio of Ti to Cl very close to an ideal 1:1 stoichiometry, suggesting full coverage of MXene surfaces with Cl was achieved. In comparison, the MXenes synthesized by the traditional MAX-exfoliation route often are significantly deficient in surface coverage, with atypical stoichiometry of Ti₂CCl_{1.5-1.7}. (V. Kamysbayev et al., Science 369, 979-983 (2020).) All these structural features, together with X-ray photoelectron spectroscopy (XPS) and assessment of crystal quality from linewidths in Raman spectra, confirm the structural perfection of the DS-Ti₂CCl₂ MXene product.

As-synthesized DS-Ti₂CCl₂ MXene stacks can be delaminated and solution-processed as individual 2D monolayers (FIG. 2C). For delamination, multilayer MXene is first intercalated with Li⁺ by treatment with n-BuLi in a hexanes solution, then shaken with polar solvents such as N-methylformamide (NMF) to form a stable suspension of delaminated 2D sheets. Insoluble TiCₓ byproducts can be selectively precipitated by a mild centrifugation at 240 g for 15 min. In delaminated DS-Ti₂CCl₂, the (0001) diffraction peak shifts to a lower 2θ angle of 7.02°, corresponding to the enlarged d-spacing value of 12.54 Å, from the original 8.70 Å. A similar d-spacing expansion was found in delaminated Ti₃C₂Cl₂ MXenes (from 11.08 Å to 14.96 Å). (V. Kamysbayev et al., 2020.)

FIG. 2G shows a powder XRD pattern for a DS-Ti₂CCl₂ prepared by reacting Ti, carbon nanotubes (CNTs) or C₆₀, and TiCl₄ in a reaction vessel at 950° C. FIG. 2H shows and SEM image of the DS-Ti₂CCl₂ prepared by reacting the Ti, C₆₀, and TiCl₄.

### Supplementary Information:

Chemicals and materials (for Example 1 and Example 2, below).

Ti powder (˜325 mesh, 99%), graphite powder (natural, ˜325 mesh, ≥99.8%), Al powder (99.5%, 325 mesh), CdCl₂ (99.996%, ultra dry), NaCl (99.99%, ultra dry), KCl (≥99.95%, ultra dry), CsBr (99.9%, ultra dry), KBr (99.9%, ultra dry), LiBr (99.9%, ultra dry), LiH (99.4%), Li₂O (99.5%), and 2.6-difluoropyridine (DFP, >98%) were purchased from Alfa Aesar. NaNH₂ (99%, extra pure) was purchased from Acros Organics. TiCl₃ powder (Al reduced, ≥98%), TiCl₄ (99%), ZrCl₄ powder (≥99.5% Zr), and ZrBr₄ powder (≥99% Zr) were purchased from Strem Chemicals. Ti foil (thickness 0.025 mm, 99.98%), Zr foil (thickness 0.10 mm, 99.98%), N₂H₄ (98%, anhydrous), n-butyllithium (n-BuLi, 2.5 M in hexanes), MeOH (99.8%, anhydrous), MeCN (99.8%, anhydrous), THF (99.9%, anhydrous), hexane (95%, anhydrous), N-methyl formamide (NMF, 99%), and LiPF₆ solution (LP30, 1 M LiPF₆ in 50:50 vol/vol ethylene carbonate/dimethyl carbonate, battery grade) were purchased from Sigma. NMF was purified by distillation before handling in a glovebox. HCl (36.5-38%) was purchased from Fisher. Fused quartz tubes (10 mm O.D., 8 mm I.D.) and rods (7 mm O.D.) for ampoule fabrication were purchased from Technical Glass Products, Inc. Al foil (99.95%, thickness=15 μm), lithium foil (99.9%, thickness=0.6 mm, diameter=16 mm), super P conductive carbon black (acetylene black), polyvinylidene difluoride powder (PVDF, ≥99.5%), PP/PC/PP spacers (PP=polypropylene, PC=polycarbonate) were purchased from MTI Corp. Ar gas (ultra high purity grade), Ar/CH₄ gas (5% methane, nuclear counter ultra high purity grade), Ar/H₂ gas (5% hydrogen, ultra high purity grade), and N₂ gas (ultra high purity grade) were purchased from Airgas.

### Direct Synthesis of Ti₂CCl₂

DS-Ti₂CCl₂ was synthesized by the reaction of TiCl₃ or TiCl₄ with Ti powder and graphite powder. All the syntheses were conducted under Ar atmosphere in a drybox unless otherwise noted.

For the TiCl₃ reaction, TiCl₃. Ti, and graphite powders were ground into a fine powder in a 2.2:4:2.7 molar ratio. The resulting powder was pressed into a pellet under ˜0.77 GPa of pressure using a hydraulic press, then sealed inside a quartz ampoule under vacuum.

For the TiCl₄ reaction, Ti and graphite powders were ground into a fine powder in a 3:1.8 molar ratio. The resulting powder was transferred into a quartz test tube using a glass funnel, followed by addition of 1.1 molar equivalent TiCl₄. The test tube was chilled by liquid nitrogen to reduce loss of TiCl₄ to vaporization and sealed under vacuum.

To initiate the reaction, the ampoules were put inside a muffle furnace and heated to desired reaction temperature in 20 min. The temperature was maintained until the reaction was finished; typically, 2 h at 950° C. is sufficient for maximum yield of MXene. The ampoules were then naturally cooled to room temperature.

### Synthesis of MS-Ti₂CCl₂ MXene

Ti₂AlC MAX phase and MS-Ti₂CCl₂ MXene were synthesized using the modified molten salt approach described elsewhere. (V. Kamysbayev et al., 2020.) Ti (0.356 g), graphite (0.045 g) and Al (0.120 g) powders were mixed with NaCl (0.870 g) and KCl (1.109 g) salts using a mortar and pestle. The resulting mixture was heated in an alumina crucible at 1080° C. for 2 h under a flow of Ar.

Ti₂AlC (0.500 g) MAX phase was mixed with CdCl₂ salt in a 1:8 molar ratio using a mortar and pestle. The resulting mixture was heated in an alumina crucible at 610° C. for 6 h. The MS-Ti₂CCl₂ MXene was recovered from the reaction mixture by dissolving excess CdCl₂ and Cd metal in concentrated aqueous HCl, followed by washing with deionized water until the washings had neutral pH. The resulting MXene powder was dried under vacuum at 40° C. for >12 h before further characterization.

### Synthesis of TiCl₂

TiCl₂ flakes were prepared by the comproportionating reaction of Ti powder and TiCl₄ in a quartz ampoule at 1050° C. This temperature was slightly higher than the melting point of TiCl₂ (1035° C.), since otherwise the Ti powder would be covered by a layer of TiCl₂, causing incomplete conversion. 0.048 g Ti powder was transferred into a quartz test tube (˜10 cm ampoule length) using a long neck glass funnel, followed by addition of 0.209 g TiCl₄. The test tube was chilled by liquid nitrogen to reduce loss of TiCl₄ to vaporization and sealed under vacuum. To initiate the reaction, the ampoule was put inside a muffle furnace and heated to 1050° C. in 20 min. The temperature was held at 1050° C. for 1 day, and then the ampoule was naturally cooled to room temperature.

Delamination of DS-Ti₂CCl₂.

DS-Ti₂CCl₂ was delaminated using the modified n-BuLi treatment method. 4 g DS-Ti₂CCl₂ was immersed in 10 mL of 2.5 M n-BuLi hexanes solution in a sealed vial, then stirred at room temperature for 16 h inside the N₂ filled glovebox. The lithium-intercalated MXene was washed with hexane followed by THF to remove excess n-BuLi and organic residues. After that, 20 mL anhydrous NMF was added to disperse the intercalated MXene by shaking, forming a dark black colloidal solution. The supernatant was collected after centrifuging at 240 g for 15 min to remove most multilayer MXenes and insoluble TiCₓ. Finally, the supernatant containing delaminated MXene was centrifuged at 12100 g for 15 min to precipitate the MXenes, leaving small impurities in solution. The sediment was redispersed in fresh NMF or DFP to form a stable colloidal solution (˜25 g·L⁻¹) of delaminated MXene.

### Characterization Methods

The structure and composition of MXenes were characterized using x-ray characterizations, Raman spectroscopy, electron microscopy and a combination of energy dispersive x-ray spectroscopy (EDX) and electron energy-loss spectroscopy (EELS) analysis.

### X-Ray Diffraction (XRD).

The diffraction patterns in Bragg-Brentano geometry were obtained using a Rigaku benchtop X-ray diffractometer equipped with HyPix-400 MF 2D hybrid pixel array detector (HPAD) and a Cu Kα X-ray source (1.5406 Å) operating at 40 kV and 15 mA.

XRD full pattern fitting (Rietveld refinement) was performed using Bruker TOPAS Version 5 software. The Ti₂CCl₂ MXene samples were assumed to contain two major phases: Ti₂CCl₂ MXene (space group P-3m1) and TiCₓ (space group Fm-3m). The CVD-Ti₂NCl₂ MXene sample was assumed to contain two phases: a major Ti₂NCl₂ MXene phase (space group P-3m1) and a trace amount of TiNₓ (space group Fm-3m). The Zr MXene samples were assumed to contain two major phases: Zr₂CX₂ MXene (space group P-3m1, X=Cl or Br) and MCx carbide (space group Fm-3m, M=Ti, Zr or Hf). The Stephens model (trigonal symmetry) was used to account for the anisotropic peak broadening of the XRD pattems of the MXene phases. (P. W. Stephens, Phenomenological model of anisotropic peak broadening in powder diffraction. J. Appl. Crystallogr. 32, 281-289 (1999).)

### Raman Spectroscopy.

Raman spectra were obtained with a Horiba LabRAM HR Evolution confocal microscope. A Si (111) wafer was used for calibration. The samples were excited using a 633 nm light source with 100× long path objective and a 600 lines mm⁻¹ grating. The laser power was set to 1% for measurements on DS-Ti₂CCl₂, MS-Ti₂CCl₂, and CVD-Ti₂NCl₂ samples because degradation was observed at higher powers. 5% power could be used for characterizing CVD-Ti₂CCl₂ MXene without noticeable degradation.

### Scanning Electron Microscopy-Energy Dispersive X-Ray Spectroscopy (SEM-EDX).

SEM imaging and EDX elemental mapping were performed in a Carl Zeiss Merlin Field-Emission Scanning Electron Microscope equipped with Oxford Ultim Max 100 Silicon Drift Detectors (SDD). The accelerating voltage was set to 10 kV and beam current was set to 1 nA.

### Focused Ion Beam-Scanning Electron Microscopy (FIB-SEM).

FIB milling and SEM imaging were performed at the Canadian Centre for Electron Microscopy using a Thermo Scientific Helios 5 UC Scanning Electron Microscope equipped with Tomahawk HT Focused Ion Beam and Easy-lift in situ manipulation system. Carbon coating was performed with MultiChem gas-delivery system prior to milling to protect sample from degradation.

### Scanning Transmission Electron Microscopy (STEM).

Atomic-resolution characterization of the MXene samples was conducted using the aberration-corrected scanning transmission electron microscope (STEM) JEOL ARM200CF at the University of Illinois Chicago, equipped with a cold field emission gun operated at 200 kV, a Gatan Continuum electron energy-loss spectrometer (EELS), and an Oxford XMAX100TLE X-ray detector, providing a sub-A probe-size and 350 meV energy resolution. The emission current was reduced to 12 Å to reduce damage from the electron beam. An electron probe convergence semi-angle of 24 mrad was used and the inner detector angle for high-angle annular dark-field (HAADF) imaging was chosen to be 75 mrad, while an inner angle for low-angle annular dark-field (LAADF) imaging was chosen at 30 mrads. The MXene samples were initially prepared for STEM analysis by drop casting particles suspended in methanol alcohol onto a 3 nm holey-carbon covered TEM grid, which was allowed to dry over 2 hours in a N₂ glovebox maintained at <0.1 ppm H₂O and O₂. The TEM grids were then loaded onto a plasma cleaned Fischione vacuum transfer holder and inserted into the microscope column without atmospheric exposure.

### Transmission Electron Microscopy (ThM).

TEM data were obtained from a 300 kV FEI Tecnai G2 F30 microscope. TEM samples were prepared by drop-casting and drying colloidal solutions diluted in NMF on Ted Pella lacey carbon grids under nitrogen atmosphere. After drying the solutions, fresh acetonitrile was drop-cast onto the sample grids to wash away any remaining NMF. The grids were then dried under vacuum.

### Atomic Force Microscopy (AFM).

AFM imaging was performed with an Asylum Research Cypher ES Atomic Force Microscopy using its tapping mode. In order to observe thin MXene flakes, AFM samples were prepared by drop-casting and drying diluted delaminated MXene NMF solutions on Si wafers under nitrogen atmosphere.

### X-Ray Fluorescence (XRF).

XRF analysis was performed with a benchtop Energy Dispersive Rigaku NEX DE VS X-ray fluorimeter equipped with a Peltier cooled FAST SDD Silicon Drift Detector. All analyses were carried out under He atmosphere to increase sensitivity for lighter elements. Elemental ratios were determined using the standardless thin films fundamental parameters method as programmed in QuantEZ software provided by Rigaku, using the standard Rigaku calibration protocols. The samples were prepared by drop casting powders dispersed in anhydrous methanol on a Si substrate of an approximate 1×1 cm² size. The analysis window during measurement was set to a diameter of 10 mm.

### X-Ray Photoelectron Spectroscopy (XPS).

XPS analysis was performed on a Kratos Axis Nova spectrometer using a monochromatic Al Kα source (1486.6 eV). Ti 2p, C 1s, and N is high-resolution spectra were collected using an analysis area of 0.3×0.7 mm² and a 20 eV pass energy with a step size of 100 meV. Peak fitting of high-resolution XPS spectra was performed with CasaXPS software. A Tougaard background was used for better quantification of transition metal-based compounds. The Ti 2p region consists of the two 2p_{3/2} and 2p_{1/2} components arising from spin-orbit splitting; the peak area ratio of 2p_{3/2} to 2p_{1/2} was fixed to 2:1. The Ti²p region was fit using three pairs of²p_{3/2} and²p_{1/2} components for each sample: two for the MXene components and one for TiO₂. The two pairs of MXene component peaks were fit using the asymmetric Lorentzian line shape. The TiO₂ peaks were fit using a symmetric Lorentzian-Gaussian line shape. The binding energies for electrons in the C—Ti—C site in bulk TiC are indistinguishable from those in the C—Ti—Cl site of MXenes by conventional XPS. The C is and N is regions were fit using symmetric Lorentzian-Gaussian line shapes. Since the Fermi edges were not sharp enough to use for calibration, the binding energy of the C is peak for Ti—C—Ti was fixed at 282.0 eV to compensate for any shifts caused by sample charging. For nitride CVD-Ti₂NCl₂ MXene, calibration was performed by setting the C is adventitious carbon peak to 284.8 eV.

### Weight Percentage of MXene.

For DS-Ti₂CCl₂, the MXene content (wt %) was estimated based on combustion elemental analysis by Atlantic Microlab, Inc. The samples were carefully washed with hydrochloric acid, water, and ethanol to remove all soluble by-products, then vacuum dried before testing. Very low hydrogen content proves that the samples have been dried properly.

According to the Rietveld refinement results, only two crystalline phases were present: MXene phase and TiCₓ phase. The Ti:Cl atomic ratio within MXene flakes was found close to 1:1 by STEM-EDX analysis. Based on above mentioned information, the wt % of MXene can be calculated by assuming that MXene phase is the only component that contains Cl and that the stoichiometry of the MXene phase is Ti₂CCl₂.

wt % (MXene)=wt % (Cl)/Mᵣ(Cl)*Mᵣ[(Ti₂CCl₂)_{1/2}]

### Example 2: CVD Synthesis of MXenes Using Metal Halides

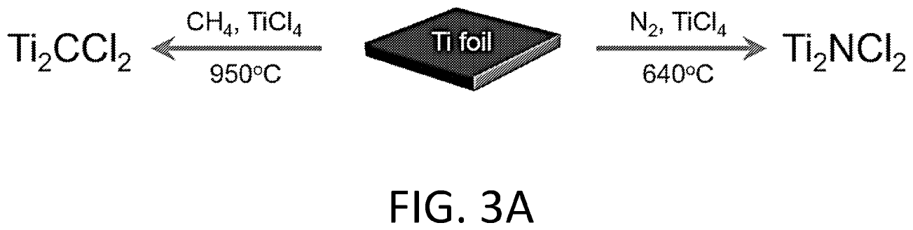

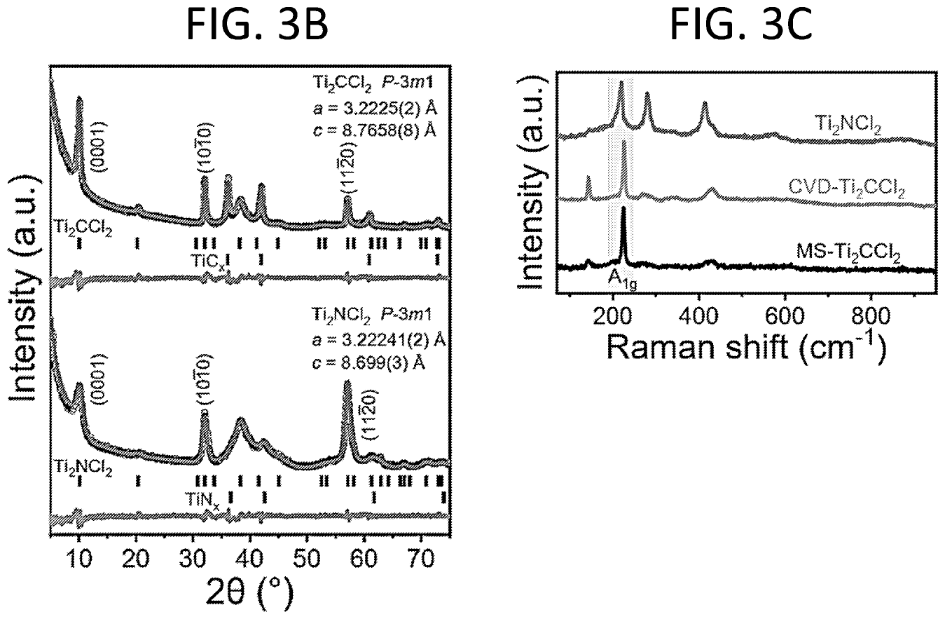

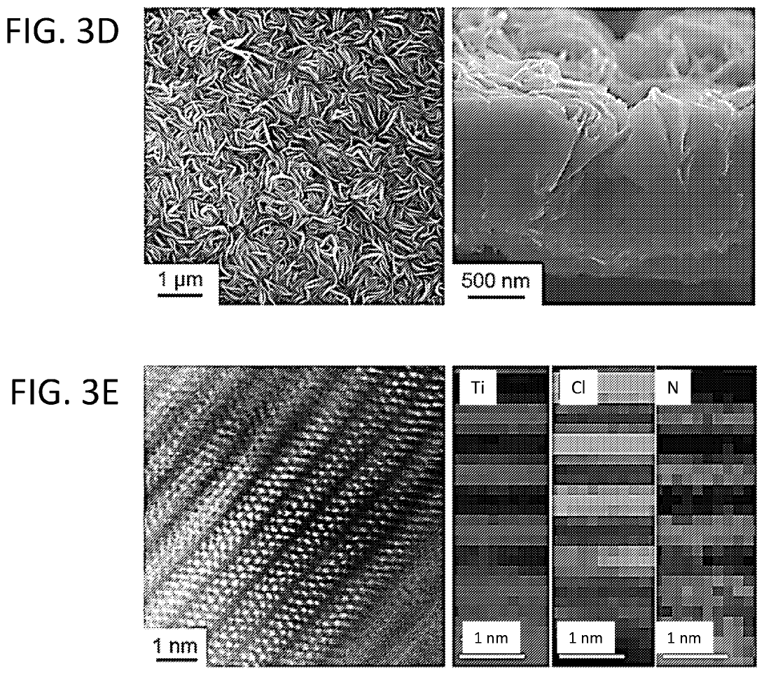

In this Example, the direct synthesis of MXenes through CVD (CVD-MXenes) was demonstrated to show that CVD offers a route to completely new morphologies of MXenes. Although transition metal carbides and nitrides such as Mo₂C, WC, and Mo₂N can be grown by CVD, such synthetic options have not been previously available for MXenes. The inventors have now succeeded in growing MXenes by CVD on a Ti surface with a CH₄ and TiCl₄ gas mixture diluted in Ar (FIG. 3A). After the exposure of Ti foil to TiCl₄ and CH₄ vapor at 950° C. for 15 min, the as-synthesized product (denoted as CVD-Ti₂CCl₂) was characterized by XRD (FIG. 38). According to the Rietveld refinement, the lattice parameters a=3.2225(2) A and c=8.7658(8) A match well the reported values for Ti₂CCl₂ MXene. (V. Kamysbayev et al., 2020.) Raman spectra (FIG. 3C) also confirm the purity of Ti₂CCl₂ MXene. High resolution STEM-EELS and EDX analysis confirm the crystallinity and ideal stoichiometry of CVD-Ti₂CCl₂. The center-to-center interlayer distance of 0.88 nm calculated from STEM images was typical for Ti₂CCl₂ MXenes. SEM images showed a substrate fully covered with a wrinkled layer of CVD-Ti₂CCl₂ (FIG. 3D). A dense carpet of Ti₂CCl₂ MXene sheets grown perpendicular to the substrate would be difficult to achieve for traditionally-synthesized MXenes. This morphology appears particularly promising for efficient ion intercalation and fast charging/discharging cycles.

CVD growth of MXenes involves the reaction of gaseous reagents with the titanium surface. As the thickness of growing MXene carpet increased, the diffusion of gaseous reagents toward the reaction zone (FIG. 4A) slowed down, and the growth of the MXene carpet was expected to be self-limiting. However, the emergence of a new growth mechanism that bypassed this kinetic bottleneck (FIG. 4B) was observed. The uniform growth of MXene carpet (FIG. 4D) was followed by the formation of “bulges” (FIG. 4C) that further evolved into MXene “vesicles” (FIG. 4D). Next, these “vesicles” detached from the substrate and could be collected and imaged by SEM and TEM (FIGS. 4D-4F). The process repeats itself, enabling continuous synthesis of MXenes. The internal structure of CVD-MXene “vesicles” was composed of individual Ti₂CCl₂ sheets radiating from the center and oriented normal to the surface (FIGS. 4G, 4H). Imaging of a fragmented “vesicle” (FIG. 4E) and individual “vesicles” dissected with a focused ion beam revealed a small void at the “vesicle” centers. FIGS. 41 and 4J show SEM images of the CVD-Ti₂CCl₂ microspheres before (FIG. 4I) and after FIB milling (FIG. 4J).

The complexity of this hierarchical organization of CVD-Ti₂CCl₂ “vesicles” is unusual for inorganic solids. The MXene carpet formed at an early stage of CVD growth (FIG. 4C) can be approximated as an elastic sheet with the equilibrium energy defined through the surface area S, surface tension γ, local curvature, and bending rigidity k. If γ, k>0, the sheet naturally prefers equilibrium flat geometry. However, when new material is constantly added to the sheet, the standard equilibrium description fails to predict its shape and stability. When elastic membranes are forced to grow, their evolution can be modeled in terms of an effective decreased surface tension, γ_{eff}=γ−α\acute{m}, where m is the rate at which material is added to the sheet and a is a phenomenological constant. If the growth rate exceeds a critical threshold, \acute{m}c=γ/α, the effective surface tension takes negative values. A negative surface tension then implies that certain fluctuations of the elastic sheet grow rapidly, resulting in an instability. Van der Waals bonded 2D MXene sheets can efficiently slide against each other, creating only a small elastic penalty for the formation of buckled and curved geometries. If the sheet is just loosely connected to the underlying substrate, these deformations can collapse into spherical “vesicles”, refreshing the substrate for further growth, as schematically shown in FIG. 4B. Such evolution of MXene carpets during CVD growth conceptually resembles the dynamics of cell membranes during endocytosis. A recent theoretical work illustrated how negative surface tension brought about by growth could lead to a variety of non-trivial geometries similar to the experimentally observed MXene “vesicles”. (J. Binysh, et al., Sci. Adv. 8, eabk3079 (2022).) Various supporting evidence was found for the above sequence of growth stages.

Direct CVD synthesis can be employed to produce MXenes that have not been previously prepared by the etching of MAX phases. For example, Zr₂CCl₂ and Zr₂CBr₂ MXenes were synthesized by exposing a Zr foil to CH₄ and ZrCl₄ or ZrBr₄ vapor at 975° C. These two zirconium MXenes appeared in the same general morphology as the titanium MXenes, adopting a vertically aligned carpet-like structure on the surface of the Zr foil.

Arguably the most intriguing product of the direct synthesis was phase-pure nitride Ti₂NCl₂ MXene formed via the reaction of Ti foil with TiCl₄ and N₂ above 600° C. (FIGS. 2B, 2C). To the best of the inventors' knowledge, neither this reaction nor this MXene phase have been reported previously, but it has been predicted for nitride MXenes to have a variety of attractive properties, including ferromagnetism and higher conductivity as compared to carbide MXenes. (H. Kumar et al., ACS Nano 11, 7648-7655 (2017).) To date, only a few nitride MXenes have been synthesized, and experimental realization of chlorine terminated nitride MXenes has not been achieved. This CVD method, using N₂ as the nitrogen source, further proves the versatility of bottom-up MXene syntheses. These reactions can be important beyond MXene synthesis. Given that TiCl₄ plays the key role in Ti metallurgy (Kroll process) and in the synthesis of TiO₂ from titanium ores (chloride process), both being produced on the millions of tons annually, the above reactions create opportunities, e.g., for nitrogen fixation as a side process in conventional TiO₂ synthesis.

### Supplementary Information:

CVD ofTi2CCl₂ and Ti₂NCl₂MXene.

A piece of 1×1 cm² Ti foil (˜20 mg) was placed inside a BN boat, then loaded into the heating zone of a horizontal tube furnace. The foil was heated to 950° C. (640° C. for Ti₂NCl₂) in 20 min under Ar/H₂ atmosphere (300 sccm). After that, the Ar/H₂ flow was cut off and a flow of Ar/TiCl₄ (120 sccm, 1.7% TiCl₄) and Ar/CH₄ (5 sccm, 5% CH₄; 0.5 sccm N₂ for Ti₂NCl₂) was introduced to initiate the reaction. After deposition (typically 15 to 60 min), the Ar/CH₄ or N₂ flow was cut off and the Ti foil was rapidly cooled to room temperature by opening the lid of the splitable furnace. The CVD MXenes were scraped off the Ti substrate and washed with anhydrous acetonitrile and methanol before subsequent characterization.

CVD of Zr₂CCl₂ and Zr₂CBr₂ MXene.

A piece of 1 x1 cm² Zr foil (˜90 mg) was placed inside a BN boat, then loaded into the heating zone of a horizontal tube furnace. The ZrCl₄ or ZrBr₄ precursor was placed in the furnace upstream from the foil. The foil was then heated to 975° C. in 20 min under Ar/H₂ atmosphere (300 sccm). After that, the Ar/H₂ flow was cut off and a flow of Ar (100 sccm) and Ar/CH₄ (5 sccm, 5% CH₄) was introduced to initiate the reaction. After deposition (typically 120 min), the Ar/CH₄ flow was cut off and the Zr foil was rapidly cooled to room temperature by opening the lid of the splitable furnace. The CVD MXenes were scraped off the Zr substrate and washed with anhydrous acetonitrile before subsequent characterizations.

Characterization Methods. See Example 1.

### Example 3: Direct Synthesis of MXenes Using Carbon Halides

To synthesize different M₂CX₂ MXenes (Ti₂CCl₂, Zr₂CCl₂, Zr₂CBr₂, Nb₂CCl₂, and Nb₂CBr₂ have been made), metal powder powder (Ti, Zr or Nb) was added into a quartz test tube using a glass funnel, followed by addition of the carbon halide compound (C₂Cl₄, C₂Cl₆, CBr₄). The test tube was chilled by liquid nitrogen to reduce loss of carbon halide compounds to vaporization and sealed under vacuum. The ampoule was heated at different temperatures (800-810° C. for Ti₂CCl₂, 750-800° C. for Zr₂CCl₂, ˜800-830° C. for Nb₂CCl₂, ˜740-780° C. for Nb₂CBr₂,) for 1 day, then naturally cooled to room temperature.

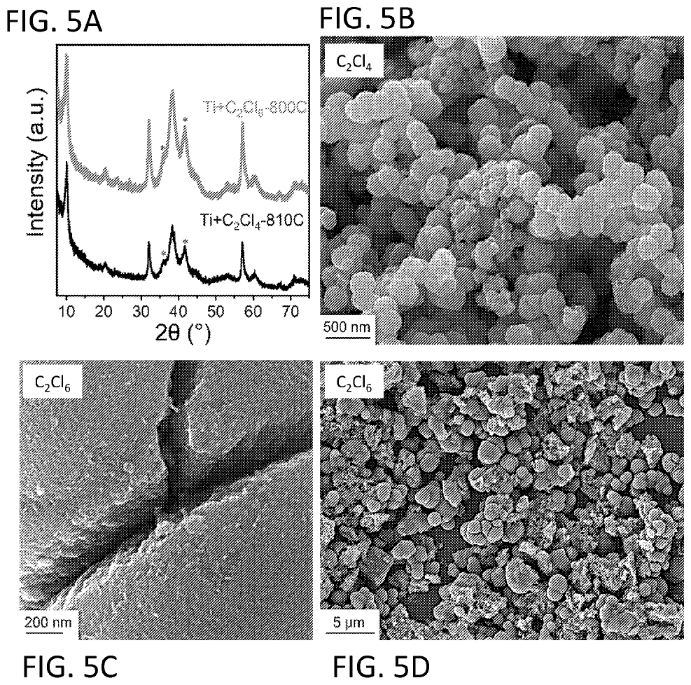

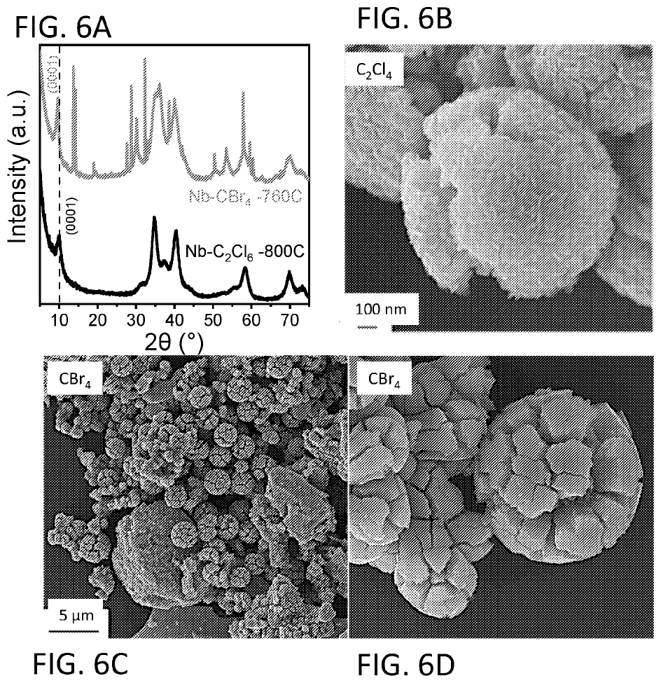

FIGS. 5A-5D show powder XRD (FIG. 5A) and SEM images (FIGS. 5B-5D) of Ti₂CCl₂ MXene (* are diffraction signals from small amount of TiCₓ byproduct) synthesized from different carbon halide compounds (C₂Cl₄— FIG. 5B and C₂Cl₆—FIGS. 5C and 5D). FIGS. 6A-6D show powder XRD (FIG. 6A) and SEM images (FIGS. 6B-6D) of Nb₂CCl₂ and Nb₂CBr₂ MXenes synthesized from different carbon halide compounds (C₂Cl₄— FIG. 6B and CBr₄—FIGS. 6C and 6D). FIG. 7 shows a powder XRD for a Zr₂CBr₂ MXene and a Zr₂CCl₂ MXene synthesized from CBr₄ and C₂Cl₄, respectively.

### Example 4: Chemical Vapor Deposition (CVD) of Nb₂CCl₂ MXenes Using Carbon Halides

A piece of 1 x1 cm² Nb foil (˜100 mg) was placed inside a BN boat, then loaded into the heating zone of a horizontal tube furnace. The foil was heated to 820° C. in 20 min under Ar/H₂ atmosphere (300 sccm, 5% H₂). After that, the Ar/H₂ flow was decreased to 5 sccm and a flow of Ar/C₂Cl₄ (50 sccm, 1.9% C₂Cl₄) was introduced to initiate the reaction. After deposition for 90 min, the C₂Cl₄ supply was cut off and the Nb foil was rapidly cooled to room temperature by opening the lid of the splitable furnace.

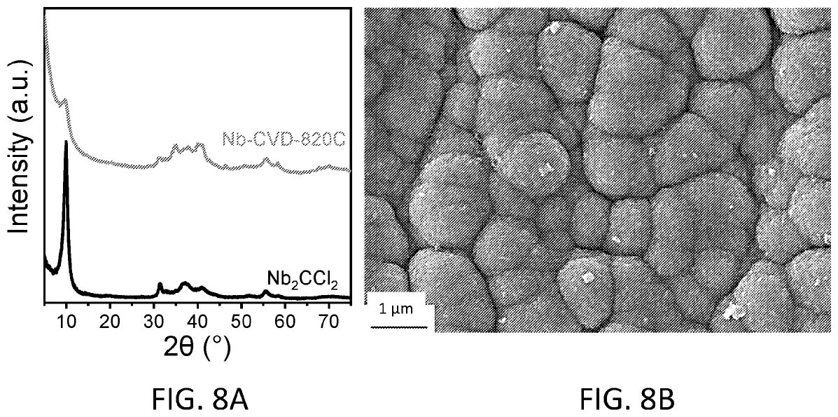

FIGS. 8A and 8B show powder XRD (FIG. 8A) and an SEM (FIG. 8B) image of Nb₂CCl₂ MXene synthesized by CVD (compared to a Nb₂CCl₂ standard) from an Nb surface and a C₂Cl₄.

### Example 5: Electrochemical Energy Storage

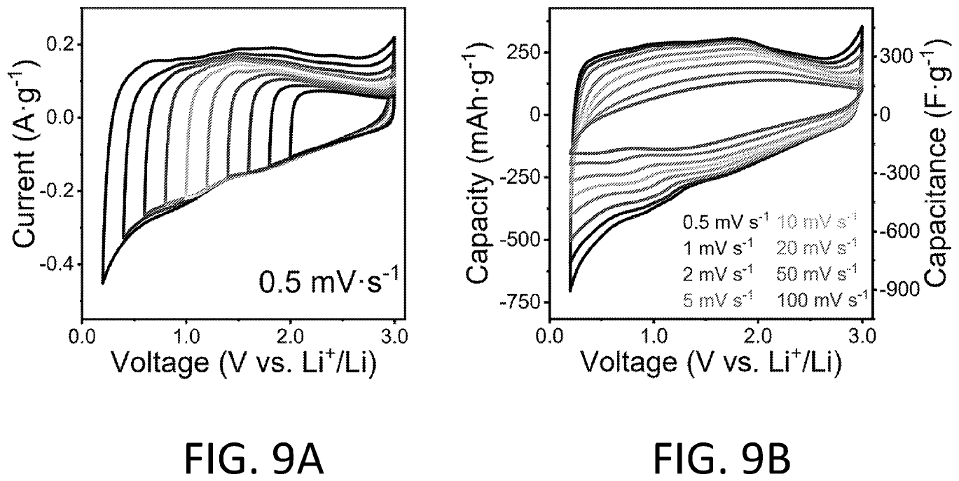

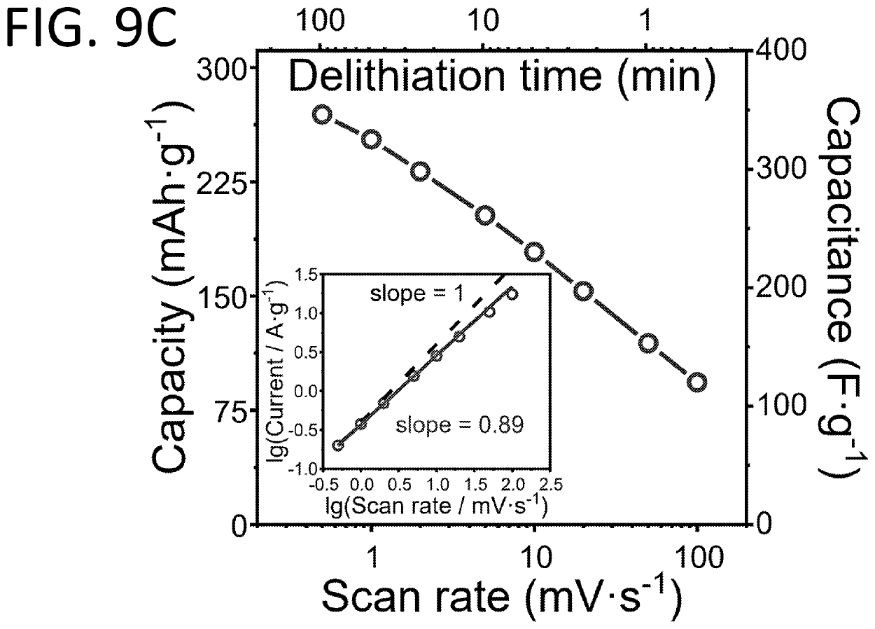

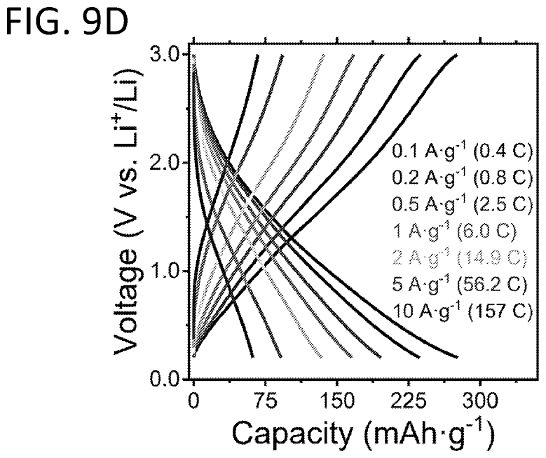

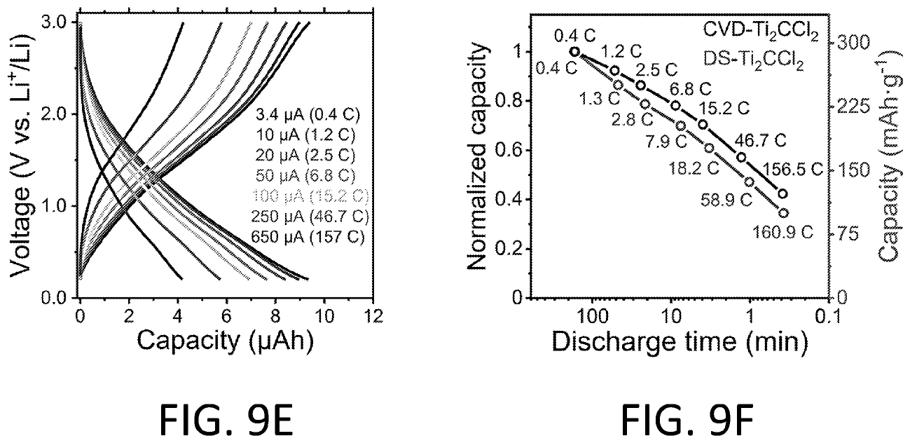

The Li-ion storage properties of electrodes prepared from DS-Ti₂CCl₂ and CVD-Ti₂CCl₂ were investigated and the results are reported in this Example. Electrochemical characterizations on DS-Ti₂CCl₂ were performed using a two-electrode (lithium coin cell) configuration. A conducting additive, 10 wt % Super P carbon black, was added following a standard approach. The first several cyclic voltammetry (CV) cycles of a delaminated DS-Ti₂CCl₂ electrode recorded at a scan rate of 0.5 mV·s⁻¹ within the electrochemical potentials from 0.2 to 3.0 V vs. Li⁺/Li showed redox peaks which can be assigned to the formation of a solid electrolyte interphase (SEI) layer. After the third CV cycle, the specific capacitance of DS-MXene electrode stabilized at 341 F·g⁻¹ (which corresponds to a capacity of 265 mAh·g⁻¹). The rectangular CV profile without redox peaks indicates a pseudocapacitive energy storage mechanism for delaminated MXenes, which is further supported by the consistency of the rectangular CV profiles recorded with different negative cut-off potentials (FIG. 9A).

The charge storage kinetics were investigated by measuring the dependence of the electrochemical current i on the potential scan rate v. In theory, the current scales with scan rate as i˜v^{b}, with b-value of 1 corresponding to a capacitive process, and h-value of 0.5 typical for battery-type energy storage. FIG. 9B presents CV profiles of delaminated DS-Ti₂CCl₂ MXene at scan rates from 0.5 to 100 mV·s⁻¹. The specific lithiation capacities and capacitances, versus charge/discharge times and scan rates calculated from the CV profiles are plotted in FIG. 9C. The inset shows the i versus v plotted in logarithmic scale from 0.5 to 100 mV·s⁻¹. A linear relationship with a slope of b≈0.89 was observed for scan rates range from 0.5 to 20 mV·s⁻¹, indicating a capacitive-like charge storage for the delaminated DS-Ti₂CCl₂ electrodes. FIG. 9D shows galvanostatic charge/discharge (GCD) profiles of a DS-Ti₂CCl₂ electrode. About 48% capacity was maintained from a current density of 0.1 to 2 A·g⁻¹. A maximum capacity of 286 mAh·g⁻¹ was recorded at a specific current of 0.1 A·g⁻¹ within 0.1 to 3.0 V. These electrochemical studies further confirm excellent electrochemical characteristics of DS-Ti₂CCl₂ MXene.

To preserve the as-synthesized morphology, CVD-Ti₂CCl₂ grown on Ti foil was directly used as an electrode for electrochemical cell. Galvanostatic plots at various current densities highlight the high-power performance of CVD-Ti₂CCl₂ electrode with vertically oriented MXene sheets in Li⁺ intercalation processes (FIG. 9E). The CVD electrode had a better high-rate performance than a delaminated MXene from 0.4 C to ˜160 C (FIG. 9F). The b-value for the CVD-Ti₂CCl₂ was calculated as 0.93, which indicates an energy storage mechanism closer to a freely diffusing capacitor.

### Supplementary Information:

### Electrochemical Characterizations.

All electrochemical characterizations were performed in a two-electrode configuration (using lithium metal as counter and reference electrodes) on a BioLogic VMP3 potentiostat system. All the coin cells were assembled in an Ar atmosphere glovebox and stored overnight before being tested.

Fabrication of DS-Ti₂CCl₂ Coin Cells.

The MXene electrodes were prepared by mixing delaminated DS-Ti₂CCl₂ powder with 10 wt % Super P carbon black and 10 wt % PVDF powders with NMF into a slurry using a mortar and pestle. The slurry was coated onto an Al foil by a typical doctor-blade method and dried overnight at 60° C. under N₂ atmosphere before cutting the coated foil into 10 mm-diameter discs to be used as the working electrodes. Metallic lithium foil was used as the combined counter and reference electrodes, LP30 as the electrolyte, and one layer of 25-μm-thick PP/PC/PP film as the separator.

### Fabrication of CVD-MXene Coil Cells.

The MXene electrodes were prepared by directly depositing CVD-Ti₂CCl₂ on a 1×1 cm² Ti foil under the aforementioned conditions for 15 min. Metallic lithium foil was used as the combined counter and reference electrodes, LP30 as the electrolyte, and two layers of 25-μm thick PP/PC/PP as the separator. Observed capacitance and observed capacity were used to quantify the energy storage performance of CVD-Ti₂CCl₂, because the mass of MXene on a Ti₂CCl₂/Ti electrode had not been precisely determined.

### Charge Storage Kinetics: B-Value Estimation.

The charge storage kinetics were investigated by determining the dependence of the current i and the scan rate v. For freely diffusing electrochemical processes, the current response to scan rate is described by:

$$i = \frac{{n}^{2} {F}^{2}}{4 RT} vA {Γ}^{*}$$

where n is the number of electrons transferred in the redox reaction, A (cm⁻²) is the electrode surface area, 1′ is the surface coverage of the adsorbed species in mol·cm⁻².

For diffusion-controlled processes, the Randles-Sevcik equation indicates that:

$$i = 0.4 \; 46 {{nFAC}^{0} ( \frac{{nFvD}_{0}}{RT} )}^{1 / 2}$$

where C⁰ (mol cm⁻³) is the bulk concentration of the analyte, D₀(cm²·s⁻¹) is diffusion coefficient of the oxidized analyte.

To sum up, examination of the exponent b-value in the equation above can be used to determine the charge storage kinetics: i˜v^{b}.

A b-value of 1 corresponds to a capacitive process, while a b-value of 0.5 identifies a current typical for battery-like energy storage. Restricted diffusion and ohmic limitations may cause deviation at high scanning speeds, so calculation of b-value was based on data points within the scanning rate range of 0.5 to 20 mV·s⁻¹. Discharge current values recorded at 1.25 V were chosen to calculate b-values.

### Calculations of Capacitance and Capacity.

The capacitance and capacity from CV profiles were calculated from discharge scan curves following:

$$c = \frac{\int \vert i \vert dt}{Vm} \\ {Q}_{m} = \frac{CV}{3.6}$$

where C is the gravimetric capacitance in F·g⁻¹, Qₘ is the gravimetric capacity in mAh·g⁻¹, i is the current recorded in A, t is the time recorded in s, V is the voltage window in V, and m is the mass of MXene in g.

The capacity from GCD profiles were calculated from discharge scan curves following:

$${Q}_{m} = \frac{i Δ t}{3.6 m}$$

Similarly, Qₘ is the gravimetric capacity in mAh·g⁻¹, i is the current recorded in A, Δt is the discharge time recorded in s, and m is the mass of MXene in g.

High-rate energy storage properties of different Ti₂CCl₂ MXene electrodes with similar mass loading were estimated by comparing the normalized galvanostatic discharge capacities. The capacities at different current densities (Qᵥ) were calculated in comparison to the capacity measured at 0.4 C (Q_{0.4C}):

$$Normalized capacity = {Q}_{v} / {Q}_{0.4 C} \times 100 \% .$$

Normalized capacities of DS-Ti₂CCl₂ and CVD-Ti₂CCl₂ electrodes are summarized in the Table below.

Galvanostatic discharge capacity of delaminated DS-Ti₂CCl₂ and CVD-Ti₂CCl₂ electrodes (FIG. 9F).

| | Current | Normalized | | Current | Normalized |
|---|---|---|---|---|---|
| C-rate | density/ | capacity | C-rate | density/ | capacity |
| (DS) | A · g⁻¹ | (DS)/% | (CVD) | μA | (CVD)/% |
| 0.4 | 0.1 | 100 | 0.4 | 3.4 | 100 |
| 1.3 | 0.2 | 86.4 | 1.2 | 10 | 92.3 |
| 2.8 | 0.5 | 78.7 | 2.5 | 20 | 86.3 |
| 7.9 | 1 | 69.9 | 6.8 | 50 | 78.2 |
| 18.2 | 2 | 60.9 | 15.2 | 100 | 70.4 |
| 58.9 | 5 | 47.1 | 46.7 | 250 | 57.1 |
| 160.9 | 10 | 34.4 | 156.5 | 650 | 42.3 |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

1. A method for the direct synthesis of a two-dimensional transition metal carbide or nitride MXene having the formula M₂XT₂, where M is an early transition metal atom, X is carbon or nitrogen, and T is a surface terminating halogen atom, the method comprising: reacting the early transition metal with a carbon halide compound or reacting the early transition metal with an early transition metal halide compound and a carbon-precursor molecule or a nitrogen-precursor molecule at temperature at which the reaction forms the two-dimensional transition metal carbide or nitride MXene.

2. The method of claim 1, wherein M is Ti, Zr, or Nb and T is Cl or Br.

3. The method of claim 1, wherein the early transition metal is reacted with the carbon halide compound to form the two-dimensional transition metal carbide MXene.

4. The method of claim 3, wherein the carbon halide compound is a carbon tetrahalide, a C₂T₄ halocarbon, or a C₂T₆ halocarbon, where the Ts are the surface terminating halogen atoms.

5. The method of claim 1, wherein the early transition metal is reacted with the early transition metal halide compound and the carbon-precursor molecule to form the two-dimensional transition metal carbide MXene.

6. The method of claim 5, wherein the early transition metal halide compound is an early transition metal trihalide or an early transition metal tetrahalide.

7. The method of claim 5, wherein the carbon-precursor molecule is a carbon particle or methane.

8. The method of claim 1, wherein the direct synthesis of the two-dimensional transition metal carbide or nitride MXene is carried out using chemical vapor deposition growth on a surface of a substrate comprising the early transition metal by:
exposing the surface to a vapor comprising the carbon halide compound or a vapor comprising the early transition metal halide compound and the carbon-precursor molecule or the nitrogen-precursor molecule; and
reacting the early transition metal of the surface with the carbon halide compound or reacting the early transition metal of the surface with the early transition metal halide compound and the carbon-precursor molecule or the nitrogen-precursor molecule at temperature at which the reactions form the two-dimensional transition metal carbide or nitride MXene.

9. The method of claim 8, wherein the two-dimensional transition metal carbide or nitride MXene is formed as a layer of two-dimensional transition metal carbide or nitride MXene sheets edge-bound to the surface.

10. The method of claim 8, wherein the two-dimensional transition metal carbide or nitride MXene is formed as vesicles comprising sheets of the two-dimensional transition metal carbide or nitride MXene extending radially outward from a central void.

11. (canceled)

12. The method of claim 8, wherein M is Ti, Zr, or Nb and T is Cl or Br.

13. The method of claim 8, wherein the early transition metal of the surface is reacted with the carbon halide compound to form a two-dimensional transition metal carbide MXene.

14. The method of claim 13, wherein the carbon halide compound is a carbon tetrahalide, a C₂T₄ halocarbon, or a C₂T₆ halocarbon, where Ts are the surface terminating halogen atoms.

15. The method of claim 8, wherein the early transition metal of the surface is reacted with the early transition metal halide compound and the carbon-precursor molecule to form a two-dimensional transition metal carbide MXene.

16. The method of claim 15, wherein the early transition metal halide compound is an early transition metal trihalide or an early transition metal tetrahalide.

17. The method of claim 15, wherein the carbon-precursor molecule is methane.

18. The method of claim 8, wherein the early transition metal of the surface is reacted with the early transition metal halide compound and the nitrogen-precursor molecule to form a two-dimensional transition metal nitride MXene.

19. The method of claim 18, wherein the early transition metal halide compound is an early transition metal trihalide or an early transition metal tetrahalide.

20. The method of claim 18, wherein the nitrogen-precursor molecule is N₂.

21. The method of claim 1, wherein the temperature is in the range from 700° C. to 1100° C.

22. A two-dimensional transition metal carbide or nitride MXene selected from the group consisting of Ti₂NCl₂ and Nb₂CBr₂.

23. Two-dimensional transition metal carbide or nitride MXene sheets, wherein: the two-dimensional transition metal carbide or nitride sheets form a layer on a surface comprising an early transition metal, and further wherein the two-dimensional transition metal carbide or nitride MXene sheets are bound to and vertically aligned on the surface comprising the early transition metal; or the two-dimensional transition metal carbide or nitride MXene sheets form a vesicle in which the two-dimensional transition metal carbide or nitride MXene sheets surround and extend radially outward from a central void.

24-27. (canceled)
